(19) United States
(12) Patent Application Publication
(10) Pub. No.: US 2017/0011076 A1
(43) Pub. Date: Jan. 12, 2017

(54) FLEXIBLE SCHEDULING IN A DATABASE SYSTEM

(71) Applicant: ALIBABA GROUP HOLDING LIMITED, George Town (KY)

(72) Inventors: Heng WANG, Hangzhou (CN); Xu CHEN, Hangzhou (CN)

(21) Appl. No.: 15/198,546

(22) Filed: Jun. 30, 2016

(30) Foreign Application Priority Data
Jul. 8, 2015 (CN) 201510398423.8

(51) Int. Cl. G06F 17/30

(52) U.S. Cl. CPC G06F 17/30306; G06F 17/303

(57) ABSTRACT

Apparatuses and methods are disclosed for database scheduling. An exemplary method may include obtaining a performance parameter associated with each of a plurality of database servers that are subject to scheduling. The method may also include selecting, among the plurality of database servers subject to scheduling, a first database server, wherein the performance parameter associated with the first database server exceeds a predetermined threshold. In addition, the method may include selecting a first database instance operating on the first database server. Moreover, the method may include migrating the first database instance to a second database server that is capable of accepting the first database instance.

### CROSS REFERENCE TO RELATED APPLICATION

The present application claims the benefits of priority to Chinese Application No. 201510398423.8, filed Jul. 8, 2015, the entire contents of which have been incorporated herein by reference.

### TECHNICAL FIELD

The present application relates to database technologies, and more particularly, to flexible scheduling methods and apparatuses in a database system.

### BACKGROUND

The development of clouding computing brings new challenges to database technologies. Traditional database services suitable for servicing a single client or workstation have to evolve into cluster-level or even datacenter-level services. In order to manage and operate the vast amount of database instances involved in such high-level services, database flexible scheduling technology has been introduced and become an important technical solution for supporting a robust clouding computing environment.

In general, database flexible scheduling involves computing a distribution of database instances among database servers according to certain triggering conditions, constraints, and a predetermined scheduling goal. Database instances are then migrated to target database servers according to the computed distribution.

Existing database flexible scheduling technologies normally adopt an optimization approach, such as methods based on minimum cost. In such methods, an objective function may be generated as the first step. Based on the objective function and constraints, an optimized scheduling strategy may be obtained through computing and searching. The computation of the optimized scheduling strategy may be implemented using various methods, such as dynamic programming, neural network, simulated annealing algorithm, supported vector machine, etc.

Existing database flexible scheduling technologies, however, have several disadvantages. First, the computation is normally very complex and inefficient. As the number of the database instances subject to the scheduling operation increases, the computation cost increases almost exponentially. Second, the cost of migration is normally quite significant. This is because the optimization-based scheduling methods aim to achieve an optimal distribution based on pure mathematical consideration, which would normally cause migration of a large number of database instances. Third, the computational jitter is relatively large, which may cause instability of the database service. This is because the optimization-based methods may be sensitive to performance changes of the database instances, causing recomputation of the objective function and the corresponding scheduling strategy, which in turn may cause local or even global jitters, affecting the stability of the database service.

### SUMMARY

In one aspect, the present disclosure is directed to a method for performing database scheduling. The method may include obtaining a performance parameter associated with each of a plurality of database servers that are subject to scheduling. The method may also include selecting, among the plurality of database servers subject to scheduling, a first database server, wherein the performance parameter associated with the first database server exceeds a predetermined threshold. The method may further include selecting a first database instance operating on the first database server. In addition, the method may include migrating the first database instance to a second database server that is capable of accepting the first database instance. The second database server is capable of accepting the first database instance when a combined performance parameter combining the performance parameter associated with the second database server and a performance parameter associated with the first database instance does not exceed the predetermined threshold.

In another aspect, the present disclosure is directed to an apparatus for performing database scheduling. The apparatus may include a memory device storing computer-readable instructions. The apparatus may also include a processor device communicatively coupled to the memory device. The computer-readable instructions, when executed by the processor device, may cause the processor device to perform various operations. The operations may include obtaining a performance parameter associated with each of a plurality of database servers that are subject to scheduling. The operations may also include selecting, among the plurality of database servers subject to scheduling, a first database server, wherein the performance parameter associated with the first database server exceeds a predetermined threshold. The operations may further include selecting a first database instance operating on the first database server. In addition, the operations may include migrating the first database instance to a second database server that is capable of accepting the first database instance. The second database server is capable of accepting the first database instance when a combined performance parameter combining the performance parameter associated with the second database server and a performance parameter associated with the first database instance does not exceed the predetermined threshold.

In a further aspect, the present disclosure is directed to a non-transitory computer-readable medium storing instructions for performing database scheduling. The instructions, when executed by a processor device, cause the processor device to perform various operations. The operations may include obtaining a performance parameter associated with each of a plurality of database servers that are subject to scheduling. The operations may also include selecting, among the plurality of database servers subject to scheduling, a first database server, wherein the performance parameter associated with the first database server exceeds a predetermined threshold. The operations may further include selecting a first database instance operating on the first database server. In addition, the operations may include migrating the first database instance to a second database server that is capable of accepting the first database instance. The second database server is capable of accepting the first database instance when a combined performance parameter combining the performance parameter associated with the second database server and a performance parameter associated with the first database instance does not exceed the predetermined threshold.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a flow chart of an exemplary database scheduling method, according to an embodiment of the present application.

FIG. 2 is a schematic diagram showing database servers and database instances subject to scheduling, according to an embodiment of the present application.

FIG. 3 shows an exemplary 2D array representing the database servers of FIG. 2 in a pruning operation, according to an embodiment of the present application.

FIG. 4 is a flow chart of an exemplary database instance migration method, according to an embodiment of the present application.

FIG. 5 is a schematic diagram of an exemplary database scheduling apparatus, according to an embodiment of the present application.

### DETAILED DESCRIPTION

Reference will now be made in detail to exemplary embodiments of the invention, examples of which are illustrated in the accompanying drawings. When appropriate, the same reference numbers are used throughout the drawings to refer to the same or like parts.

The present application discloses methods and apparatuses for performing database scheduling. Database scheduling refers to a technology for determining a distribution of database instances among database servers and migrating one or more database instances into one or more target database servers according to the distribution. Advanced database scheduling methods that provide enhanced flexibility and scalability may often be referred to as flexible database scheduling methods or elastic database scheduling methods. For simplicity, the term database scheduling is used to refer to such advanced database scheduling methods, which are the subject of this application.

A database instance is a set of memory structures that manage database files. A database is a set of physical files stored on one or more storage devices such as hard drive disks. A database server is a computer server that provides database services by hosting one or more database instances.

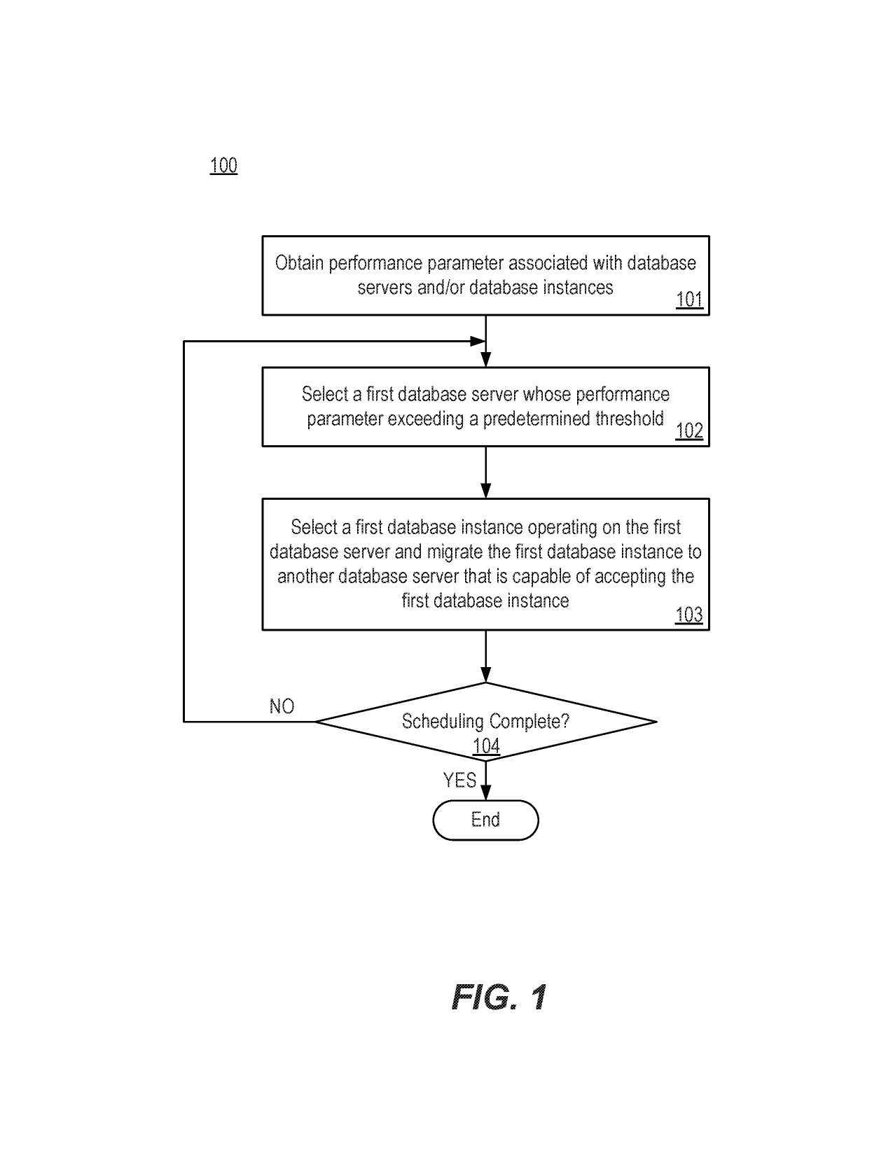

FIG. 1 is a flow chart of an exemplary method 100 for performing database scheduling. Method 100 may include various steps.

In step 101, method 100 may include obtaining performance parameters associated with database servers and/or database instances that are subject to scheduling.

A database cluster may include a plurality of database servers. Each database server may host a plurality of database instances. Each database instance may provide database service to one or more users. When the performance parameter of a database server exceeds a predetermined threshold, such as a capability threshold associated with that database server, the database server, as well as the database instances operating on the database server, may not be able to provide stable service. Under this situation, technical solutions disclosed in the present application may be used to reduce the workload of the database server by migrating one or more database instances to another database server according to a flexible scheduling strategy. Unlike the traditional optimization-based methods, the disclosed method is based on considerations of the intrinsic characteristics of the database services. This approach reduces the number of database instances subject to migration, effectively reducing the computational jittering caused by performance variations during real-time database operations.

A performance parameter may be a performance indicator reflecting the operating condition of a database server or a database instance. A performance parameter may be a single-parameter value, such as CPU usage (e.g., in percentage), memory usage (e.g., in percentage), etc. In some embodiments, each database server and each database instance operating on the database server may have a corresponding performance parameter. The predetermined threshold may refer to a pre-set operation capability indicator or limit associated with a database server based on the physical condition or configuration of the database server.

In some embodiments, the performance parameter may include multiple dimensions to indicate multiple operation conditions of a database server/database instance. For example, the performance parameter may include two or more dimensions, each corresponding to a performance indicator. Similarly, the predetermined threshold may also include multiple dimensions corresponding to the dimensions of the performance parameter. The performance parameter exceeds the predetermine threshold when at least one dimension of the performance parameter exceeds the corresponding dimension of the predetermined threshold.

In some embodiments, a five-dimensional performance parameter is used to represent the operation conditions of the database servers and database instances subject to scheduling. The five dimensions may include the following: CPU usage, disk I/O speed, memory usage, network transmission speed, and disk usage. Accordingly, the predetermined threshold may also include five threshold values corresponding to these five indicators.

In other embodiments, the performance parameter may have less than five dimensions. For example, any four of the above-listed five indicators may be used to form a four-dimensional performance parameter. Performance indicators other than the above-listed five indicators may also be used to form the performance parameter. For each dimension of the performance parameter, a corresponding threshold value may be pre-set in the predetermined threshold.

The performance parameter may be obtained using tools provided by the operating system on which the database servers operate. For example, when the database servers are MySQL servers operating on Linux system, system tools such as sar, iostat, free, df can be used to obtain the performance parameter. In addition, tools such as Cgroups can be used to collect resource usage information of each database instance. Based on the collected information and in reference to the MySQL performance indicators, performance parameter of each database instance may be obtained.

In step 102, method 100 may include selecting, among the plurality of database servers subject to scheduling, a first database server whose performance parameter exceeds the predetermined threshold.

One objective of performing flexible secluding is to reduce the workload of the database server whose performance parameter exceeding the predetermined threshold by migrating one or more of its hosted database instances, so as to reduce the performance parameter to a level equal to or below the predetermined threshold.

In some embodiments, all database servers and database instances in a database cluster may be subject to scheduling. In some embodiments, to improve efficiency, some database servers and/or database instances may be removed from the list of database servers/instances that are subject to scheduling using a pruning operation before performing database scheduling. For example, database servers/instances whose performance parameters cannot be lowered to the predetermined threshold through the scheduling process may be removed, reducing the computational cost in the subsequent scheduling process.

The pruning operation may be based on various constraints. One exemplary constraint may be: the performance parameter associated with any database instance operating on a database server cannot exceed the predetermined threshold associated with that database server. A determination of the constraining condition may be used as a basis for the pruning operation. For example, when the performance parameter includes five dimensions, the predetermined threshold may also include five corresponding threshold values. If any dimension of the performance parameter associated with a database instance exceeds a corresponding threshold value, a pruning operation may be performed.

The following example describes the pruning operation in greater detail. For simplicity, the five exemplary dimensions of the performance parameter may be denoted as: CPU (referring to CPU usage), IO (referring to disk IO speed), Memory (referring to memory usage), Network (referring to network transmission speed), and Disk (referring to disk usage). A database server may be represented using its IP addresses. A database instance may be represented using a combination of the IP address of the hosting server and a port number, such as IP address: port number.

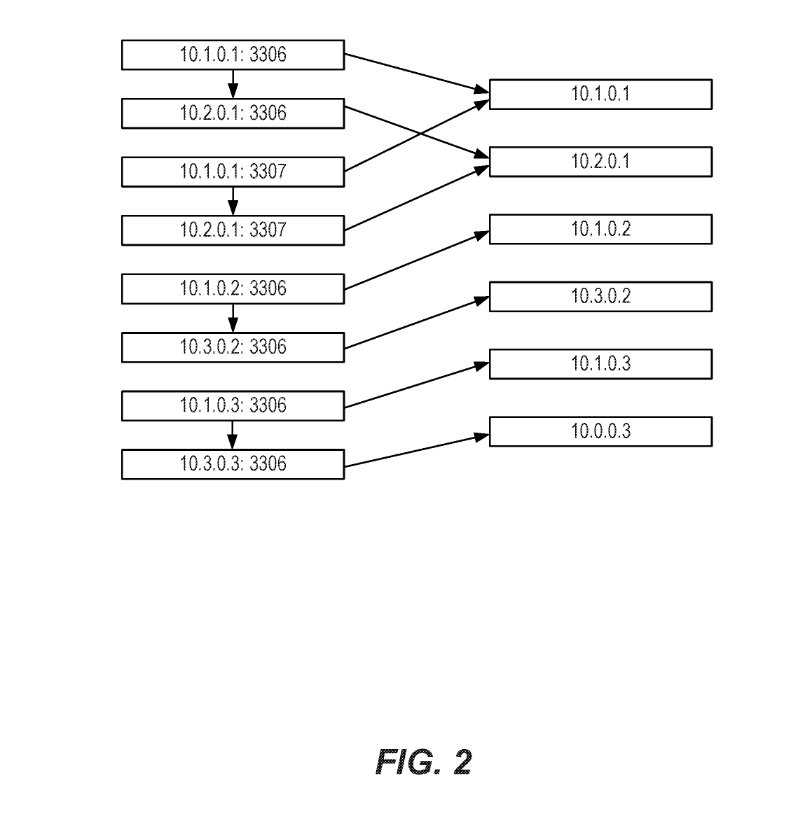

Assume that the predetermined threshold values for each database server are: CPU: 50%, IO: 20000 IO/sec, Memory: 70%, Network: 100 MB/sec, and Disk: 80%. FIG. 2 shows exemplary database servers and database instances. In FIG. 2, the vertical arrows indicate that the two database instances connected by a vertical arrow form a master-backup pair. Table 1 shows exemplary performance parameters obtained in step 101.

TABLE 1
Performance Parameters of Database Instances

| | Database | |
|---|---|---|
| ID | Instance | Performance Parameter |
| 1 | 10.1.0.1:3306 | CPU: 10%, IO: 10000, Memory: 30%, Network: |
| | | 2 0MB/s Disk: 30% |
| 2 | 10.2.0.1:3306 | CPU: 2%, IO: 100, Memory: 30%, Network: |
| | | 1 MB/s Disk: 30% |
| 3 | 10.1.0.1:3307 | CPU: 20%, IO: 2000, Memory: 30%, Network: |
| | | 50 MB/s Disk: 20% |
| 4 | 10.2.0.1:3307 | CPU: 10%, IO: 3000, Memory: 30%, Network: |
| | | 60 MB/S Disk: 20% |
| 5 | 10.1.0.2:3306 | CPU: 40%, IO: 7000, Memory: 75%, Network: |
| | | 30 MB/s Disk: 90% |
| 6 | 10.3.0.2:3306 | CPU: 5%, IO: 1000, Memory: 75%, Network: |
| | | 5 MB/s, Disk: 90% |
| 7 | 10.1.0.3:3306 | CPU: 20%, IO: 4000, Memory: 50%, Network: |
| | | 10 MB/s, Disk: 40% |
| 8 | 10.3.0.3:3306 | CPU: 5%, IO: 1000, Memory: 50%, Network: |
| | | 2 MB/s, Disk: 40% |

In this example, each database instance and its corresponding backup are processed according to the same rules. Based on the predetermined threshold, the performance parameters listed in Table 1, and constraints, it can be determined that database instances ID=5 and ID=6 cannot be properly scheduled regardless of where to migrate these two database instances, because at least one dimension of the performance parameter exceeds the corresponding threshold value. Therefore, the performance parameter of any database server accepting any of these two database instances will also exceed the corresponding threshold value. Accordingly, database instances ID=5 and ID=6 can be pruned, or removed, from the list of database instances that will be undergone the scheduling process.

Similarly, because database instances ID=5 and ID=6 will not participate in the scheduling process, these two database instances will remain operating on their respective database servers 10.1.0.2 and 10.3.0.2. Therefore, these two hosting servers will not be able to accept additional database instances. Accordingly, these two database servers can also be pruned.

The pruning process can also be performed according to other constraining conditions. For example, when a database server (e.g., 10.1.0.3) needs to be taken offline due to, for example, regular maintenance, and thus temporality stopping the database service, the database can also be pruned. If one or more database instances operate on that database server, the database instances can be migrated to other database server(s) that are capable of accepting the database instances.

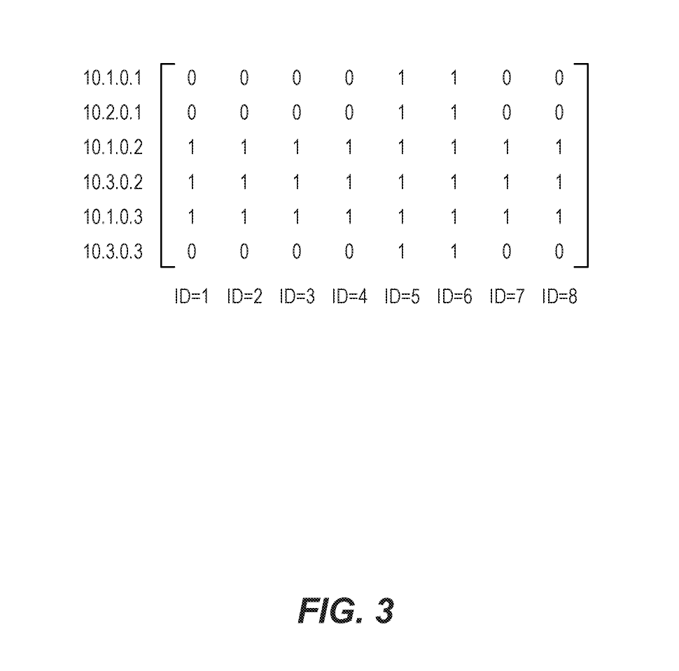

The database instances undergoing the pruning process can be represented in a 2D array, such as a bitmap, as shown in FIG. 3. In FIG. 3, one dimension of the 2D array represents database servers, while the other dimension represents database instances. The value “1” in the array represents that the corresponding database server and database instance of the coordinates of the value should be pruned. The value “0” in the array represents that the corresponding database server and database instance of the coordinates of the value should not be pruned and should participate in the scheduling process.

The pruning process can reduce the computational cost in the subsequent scheduling processing by avoiding unnecessary searches and calculations, thereby enhancing the computational efficiency of the scheduling process.

In some embodiments, the pruning process can be an optional step. The pruning process can be used in combination with the scheduling process disclosed in this application, or can be used in combination with traditional optimization-based scheduling methods. When the number of the database servers/instances is relatively small, the pruning process can be omitted.

Based on the performance parameters obtained in step 101, one or more database servers whose performance parameters exceeding the predetermined threshold may be identified in step 102. In general, when the performance parameter of a database server exceeds the predetermined threshold, the database server may not be able to provide stable services. Therefore, the workload of the database needs to be reduced. In step 102, such database servers can be identified. For example, in the above-described example where the performance parameter includes five dimensions and the predetermined threshold also include five corresponding dimensions, when at least one dimension of the performance parameter of a database server exceeds the corresponding threshold value, it is deemed that the performance parameter exceeds the predetermined threshold.

In some embodiments, the database servers participating in the scheduling process can be sorted according to their respective workloads indicated by their performance parameters. Once sorted, one or more database servers whose performance parameters exceeding the predetermined threshold may be ranked high. One of these high-ranking database servers, such as the database server having the heaviest workload may be selected as the database server for workload reduction. In some embodiments, preferring a database server having a relatively high workload to undergo the workload reduction process (e.g., the scheduling process) may establish an orderly and efficient way to distribute database instances. In situations where the total number of database servers that are capable of accepting the migrated database instances is insufficient (e.g., when the scheduling cannot guarantee the performance parameter of every database server can be reduced to a level not exceeding the predetermined threshold), preferring high-ranked database servers can ensure that priority be given to those database servers having heavy workload, thereby maintaining the database services as stable as possible.

When the performance parameter includes a single dimension, the value of the single dimension can be used as an indicator of the workload. When the performance parameter includes multiple dimensions, the value of one of the multiple dimensions can be selected as an indicator of the workload. For example, the CPU usage can be used as an indicator of the workload. A higher value of the CPU usage may indicate a heavier workload. In some embodiments, two or more of the dimensions may be selected, and a workload indicator may be calculated based on, for example, a weighted summation or average of these selected dimensions. The sorting operations described above and those will be described in the following passages can be based on the workload indicator calculated from the one or multiple dimensional performance parameter.

When the performance parameter of an unselected database server changes during real-time operation, as long as the performance parameter does not exceed the predetermined threshold, the database will not be selected to undergo workload reduction (e.g., database instance migration). Compared with the traditional optimization-based methods, which generate scheduling plans based purely on changes of performance parameters, the disclosed method has a higher tolerance to performance fluctuation, thereby avoiding unnecessary migration operations and enhancing the stability of the over services.

In step 103, method 100 may include selecting a database instance from the database server selected in step 102 and migrating the database instance into another database server that is capable of accepting the database instance.

In step 103, one or more database instances operating on the database server selected from step 102 may be migrated into other database server(s) capable of accepting the database instances, thereby reducing the workload of the database sever originally hosting the database instances. A database server capable of accepting or receiving a database instance (also referred to an accepting database server or a receiving database server) refers to a database server whose performance parameter, after adding the performance parameter of the migrating database instance, still does not exceed the predetermined threshold. In other words, the combined performance parameter of a receiving database server combining the original performance parameter of the receiving database server and the performance parameter of the migrating database instance should be equal to or less than the predetermined threshold. In general, migrating a database instance out of a database server should reduce the workload of that database server.

In some embodiments, in order to reduce the number of migrating database instance and lowering the migration cost, a search may be conducted to select a single database instance operating on the database server selected from step 102, such that migrating the single database instance would reduce the performance parameter of the database server to a level equal to or below the predetermined threshold. If such a single database instance does not exist, the database instances operating on the database server may be sorted according to their workloads, and one or more database instances having heavy workloads, or ranked higher in the sorted list, may be migrated out of the database server.

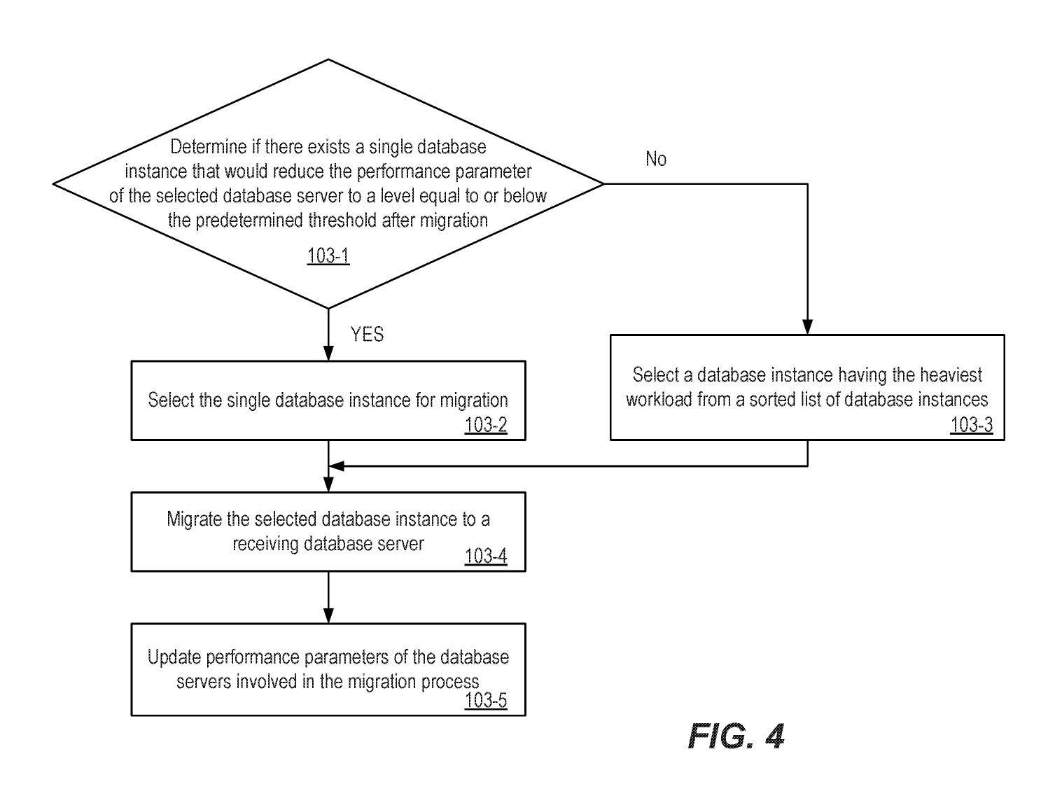

FIG. 4 is a flow chart of an exemplary migration process. Steps 103-1 to 103-5 shown in FIG. 4 form an exemplary implementation of step 103 shown in FIG. 1.

In step 103-1, a search may be conducted to determine whether there exists a single database instance hosted by the database server selected from step 102, when emigrating out of the database server, would reduce the performance parameter of the database server to a level equal to or below the predetermined threshold. If such a single database instance exists, then the process proceeds to step 103-2, otherwise, the process proceeds to step 103-3.

The search may be conducted using a traversal searching method. For each database instance operating on the database server, the performance parameter of that database instance may be subtracted from the performance parameter of the database server, and the resulting performance parameter of the database server may be compared to the predetermined threshold. If the resulting performance parameter does not exceed the threshold, then the database instance satisfies the single-database-instance requirement, and the search may be stopped. The process may proceed to step 103-02. If all database instances have been traversed and no one satisfies the requirement, then the process may proceed to step 103-03.

When the performance parameter includes a single dimension, the subtraction may be performed by directly subtracting the single-dimensional value of the database instance from the single-dimensional value of the database server. When the performance parameter includes multiple dimensions, the subtraction may be performed by subtracting corresponding dimensions of the database instance from those of the database server. In other words, the subtraction may be performed in each dimension separately.

In step 103-2, the single database instance that satisfies the requirement of step 103-1 may be selected as the database instance for migrating out of the database server. As described above, migrating the single database instance out of the database server would cause the performance parameter of the database server not exceeding the predetermined threshold.

In step 103-3, when no database instance satisfies the requirement of step 103-1, multiple database instances have to be migrated out of the database server in order to reduce the workload of the database server down to or below the threshold level. This situation may occur when the scales of the database instances operating on the database server are relatively small. To reduce the number of migrating database instances, it is preferred to migrating those database instances having relatively heavy workloads.

In some embodiments, the database instances operating on the database server may be sorted according to their workloads. Then, one or more highly-ranked database instances (e.g., having heavy workloads) may be selected as migrating database instances. For example, the database instance having the heaviest workload may be selected as the migrating database instance.

In step 103-4, the selected migrating database instance may be migrated to a receiving database server. As described above, the receiving database server may be a server that, after accepting the migrating database instance, the combined performance parameter does not exceed the predetermined threshold. This way, reducing the workload of one database server (e.g., the one originally hosting the migrating database instance) would not cause the performance parameter of the receiving database server to exceed the predetermined threshold.

In some embodiments, the receiving database server may be selected in the following way: First, sort all database servers that participate in the scheduling process and whose performance parameter does not exceed the predetermined threshold according to their workloads (e.g., from high to low). Then, select the first database server in the sorted list that is capable of accepting the database instance. That is, selecting the database server that has the heaviest workload, but at the same time still has capacity to accept the migrating database instance. In this way, the available resources can be utilized as efficient as possible, avoiding fragmentation and reserving resources for future migrations.

In step 103-5, the performance parameters of the database servers involved in the migrating process, such as the database server originally hosting the migrating database instance and the receiving database server, may be updated to reflect the effect of the migration.

In some cases, the selection step 102 and migration step 103 may be repeated multiple times before a predetermined completion condition is met. Each migration may affect the performance parameters of the emigrating database server and the receiving database server. Updating the performance parameters after each migration may accurately track the workload status of these database servers, facilitating future migrations.

For example, updating the performance parameters may be conducted by subtracting the performance parameter of the migrating database instance from the performance parameter of the emigrating database server (e.g., the database server originally hosting the migrating database instance) and adding the performance parameter of the migrating database instance to the performance parameter of the receiving database server.

When the performance parameter includes a single dimension, the subtraction and addition may be conducted directly. When the performance parameter includes multiple dimensions, the subtraction and addition may be conducted in a per-dimension manner, as described above.

Referring back to step 104 of FIG. 1, a completion condition is checked after the migration process. If the completion condition is not satisfied, the process loops back to step 102 to initiate another round of selection and migration operations.

In some embodiments, the completion condition may include: no database server has a performance parameter exceeding the predetermine threshold; or no receiving database server exists that is capable of accepting the migrating database instance.

When there are sufficient number of database servers, it is more likely that the scheduling process would achieve the objective that no database server has a performance parameter exceeding the predetermine threshold. In this case, the objective can be used as the completion condition.

When there are insufficient number of database servers, it may not be able to achieve the objective that no database server has a performance parameter exceeding the predetermine threshold. In this case, the completion condition may be set as no receiving database server exists that is capable of accepting the migrating database instance. For example, if among all the database servers whose performance parameter exceeding the predetermine threshold, even the one with the lightest workload cannot migrate a database instance to a receiving database server that is capable of accepting the database instance, then the scheduling process may be deemed complete.

In some embodiments, the above two completion conditions can also be used in combination: if any one of the condition is satisfied, then the scheduling process may end. Other completion conditions may also be used, such as when the number of migration exceeds a predetermined threshold value; when the number of database servers whose performance parameter exceeding the predetermined threshold is less than a pre-set number, etc.

In some embodiments, a combing operation may be performed to combine database instances operating on multiple database servers into a single database server or reducing the number of database servers required to hosting the database instances. The combing operation may reduce the number of database servers required to provide the database services, thereby reducing hardware and operation costs.

For example, the combing operation may include determining, for each database instance operating on a database server, whether there exists a receiving database server to accept that database instance. If yes, then all of the database instances operating on the database server can be migrated to other database servers and the database server can be removed from the list of database servers participating in the scheduling process. In addition, if a database server no longer hosts any database instance, the database server can be taken offline.

If at least one of the database instances operating on the database server cannot be migrated (e.g., there is no receiving database server for accepting the at least one database instance), then no migration process may be performed to any of the database instances operating on the database server, avoiding unnecessary migration cost.

In some embodiments, a looping operation may be used to conduct the combining process. In general, database servers having low workloads are more likely to be able to emigrate all of their database instances. In addition, the associated migration cost is relatively small. Therefore, if the combining process starts from those database servers having relatively low workloads, it is more likely that more database servers would be able to emigrate their entire database instances and thereafter, be taken offline. Therefore, an exemplary combining process can be implemented as follows: in a looping operation, each time before selecting a database server to perform the combining process, a sorting operation is performed to sort all eligible database servers (e.g., with their performance parameter not exceeding the predetermined threshold) according to their workloads (e.g., from light to heavy). Then, one or more database server having the lightest workload(s) may be selected as candidate(s) to undergo the combining process.

Similar to the operations in step 103-4, in order to avoid fragmentation of the resources, the receiving database server(s) for accepting the migrating database instances may be selected from those with relatively heavy workload. That is, in selecting the receiving database server(s), all eligible database servers other than the emigrating database server may be sorted according to their workloads. Then, one or more database servers having relatively heavy workloads may be selected as the receiving database servers.

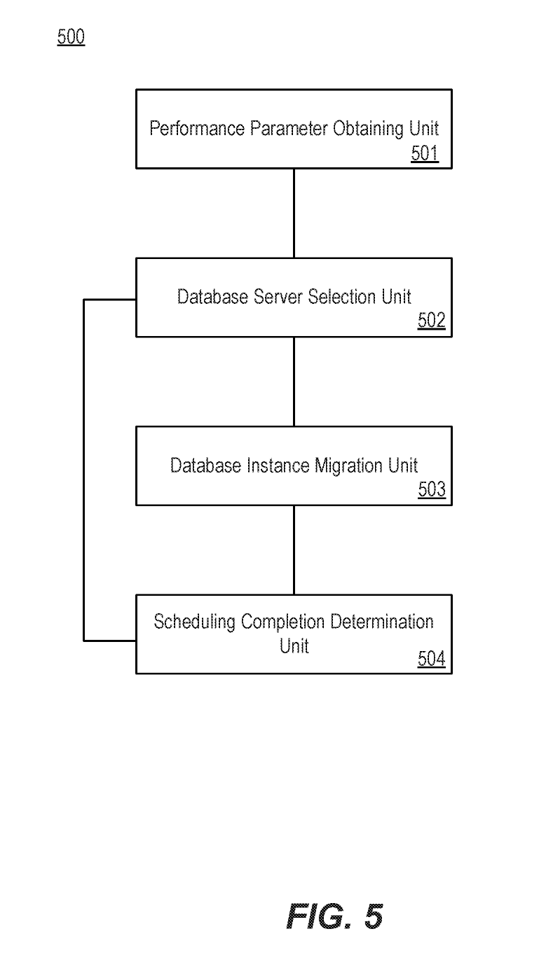

The above passages are described in connection with an exemplary method for performing database scheduling. The present application also discloses an apparatus for performing the database scheduling, corresponding to the method. FIG. 5 shows a functional block diagram of the apparatus. Because the functions of each block shown in FIG. 5 correspond to the steps shown in FIGS. 1 and 4, detail description of FIG. 5 is omitted. The following description is for illustrative purposes.

As shown in FIG. 5, apparatus 500 may include a performance parameter obtaining unit 501 configured to obtain performance parameters associated with database servers and/or database instances subject to scheduling. Apparatus 500 may also include a database server selection unit 502 configured to select one or more database servers whose performance parameter exceeding a predetermine threshold. Apparatus 500 may also include a database instance migration unit 504 configured to select a database instance from one of the selected database servers and migrate the database instance to another database server capable of accepting the database instance. Apparatus 500 may further include a scheduling completion determination unit 504 configured to determine if one or more completion conditions are met. If the completion conditions are not met, then unit 504 may trigger unit 502 to initiate a new round of selection and migration operations.

Apparatus 500 may be implemented by a computer device including a memory device and a processor device. The memory device may store computer-readable instructions. The instructions, when executed by the processor device, may cause the processor device to perform operations and functions of the various units shown in FIG. 5, as well as the functions and operations of the method shown in FIGS. 1-4.

The specification has described apparatuses and methods for performing database scheduling. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Embodiments of the present application may be implemented using hardware, software, firmware, or any combination thereof for allowing a specialized device to perform the functions described above. One or more steps, operations, functions, and modules described herein may be implemented by software instructions or codes stored in one or more memory devices and executed by one or more hardware processor devices. Exemplary hardware processor devices include logic gate circuitry configured or made to perform data processing and/or logic operations, integrated circuits (ICs) designed and made to perform specific functions, programmable gate arrays (PGAs), field-programmable gate arrays (FPGAs), etc.

Multiple function modules may be integrated into a single physical device, or may be provided in separate physical devices.

Furthermore, one or more computer-readable storage media may be utilized in implementing embodiments consistent with the present disclosure. A computer-readable storage medium refers to any type of physical and/or non-transitory memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, a volatile memory, a nonvolatile memory, a hard drive, a CD ROMs, a DVD, a flash drive, a flash memory, a cache, a register, a disk, and any other known storage media.

It is intended that the disclosure and examples be considered as exemplary only, with a true scope and spirit of disclosed embodiments being indicated by the following claims.

What is claimed is:

1. A method for performing database scheduling, the method comprising:
obtaining a performance parameter associated with each of a plurality of database servers that are subject to scheduling;
selecting, among the plurality of database servers subject to scheduling, a first database server, wherein the performance parameter associated with the first database server exceeds a predetermined threshold;
selecting a first database instance operating on the first database server; and
migrating the first database instance to a second database server that is capable of accepting the first database instance,
wherein the second database server is capable of accepting the first database instance when a combined performance parameter combining the performance parameter associated with the second database server and a performance parameter associated with the first database instance does not exceed the predetermined threshold.

2. The method of claim 1, wherein:
the performance parameter includes two or more dimensions;
the predetermined threshold includes the same number of dimensions as the performance parameter, each dimension of the predetermined threshold corresponding to a respective dimension of the performance parameter; and
the performance parameter associated with the first database server exceeds the predetermined threshold when at least one dimension of the performance parameter exceeds the corresponding dimension of the predetermined threshold.

3. The method of claim 2, wherein:
the performance parameter includes no more than five dimensions; and
the dimensions of the performance parameter are selected from a group consisting of: CPU usage, disk I/O speed, memory usage, network transmission speed, and disk usage.

4. The method of claim 1, wherein selecting the first database server includes:
sorting the plurality of database servers according to their respective workloads indicated by the corresponding performance parameters; and
selecting the first database server from the sorted plurality of database servers, wherein the first database server has a heaviest workload.

5. The method of claim 1, wherein selecting the first database instance includes:
determining whether the first database server includes a single database instance, when emigrating from the first database server, will reduce the performance parameter associated with the first database server to a level equal to or below the predetermined threshold.

6. The method of claim 5, further comprising:
when the single database instance exists, selecting the single database instance as the first database instance.

7. The method of claim 5, further comprising:
when the single database instance does not exist:
sorting database instances operating on the first database server according to their respective workloads; and
selecting the first database instance from the sorted database instances, wherein the first database instance has a heaviest workload.

8. The method of claim 1, further comprising:
sorting database servers whose performance parameters do not exceed the predetermined threshold according to their respective workloads; and
selecting the second database server from the sorted database servers, wherein the second database server has a heaviest workload.

9. The method of claim 1, further comprising:
updating performance parameters associated with the first and second database servers.

10. The method of claim 1, further comprising:
selecting, among database servers whose performance parameters do not exceed the predetermined threshold, a third database server, on which one or more database instances operate;
for each of the one or more database instances, determining whether there exists a database server capable of accepting that database instance; and
when it is determined that for each of the one or more database instances, there exists a database server capable of accepting that database instance, migrating all database instances operating on the third database server into their respective accepting database servers; and
removing the third database server from the plurality of database servers subject to scheduling.

11. The method of claim 10, further comprising:
sorting database servers whose performance parameters do not exceed the predetermined threshold according to their respective workloads; and
selecting the third database server from the sorted database servers, wherein the third database server has a heaviest workload.

12. The method of claim 1, further comprising:
determining a performance parameter associated with each database instance operating on each of the plurality of database servers subject to scheduling;
determining whether there exists a database instance whose performance parameter exceeds the predetermined threshold; and
when it is determined that there exists a database instance whose performance parameter exceeds the predetermined threshold, removing a corresponding database server hosting the database instance from the plurality of database servers subject to scheduling.

13. An apparatus for performing database scheduling, comprising:
a memory device storing computer-readable instructions; and
a processor device communicatively coupled to the memory device, wherein the computer-readable instructions, when executed by the processor device, cause the processor device to perform operations including:
obtaining a performance parameter associated with each of a plurality of database servers that are subject to scheduling;
selecting, among the plurality of database servers subject to scheduling, a first database server, wherein the performance parameter associated with the first database server exceeds a predetermined threshold;
selecting a first database instance operating on the first database server; and
migrating the first database instance to a second database server that is capable of accepting the first database instance,
wherein the second database server is capable of accepting the first database instance when a combined performance parameter combining the performance parameter associated with the second database server and a performance parameter associated with the first database instance does not exceed the predetermined threshold.

14. The apparatus of claim 13, wherein the operation of selecting the first database server includes:
sorting the plurality of database servers according to their respective workloads indicated by the corresponding performance parameters; and
selecting the first database server from the sorted plurality of database servers, wherein the first database server has a heaviest workload.

15. The apparatus of claim 13, wherein the operation of selecting the first database instance includes:
determining whether the first database server includes a single database instance, when emigrating from the first database server, will reduce the performance parameter associated with the first database server to a level equal to or below the predetermined threshold.

16. The apparatus of claim 15, wherein the operations further include:
when the single database instance exists, selecting the single database instance as the first database instance.

17. The apparatus of claim 15, wherein the operations further include:
when the single database instance does not exist:
sorting database instances operating on the first database server according to their respective workloads; and
selecting the first database instance from the sorted database instances, wherein the first database instance has a heaviest workload.

18. The apparatus of claim 13, wherein the operations further include:
sorting database servers whose performance parameters do not exceed the predetermined threshold according to their respective workloads; and
selecting the second database server from the sorted database servers, wherein the second database server has a heaviest workload.

19. The apparatus of claim 13, wherein the operations further include:
selecting, among database servers whose performance parameters do not exceed the predetermined threshold, a third database server, on which one or more database instances operate;
for each of the one or more database instances, determining whether there exists a database server capable of accepting that database instance; and
when it is determined that for each of the one or more database instances, there exists a database server capable of accepting that database instance, migrating all database instances operating on the third database server into their respective accepting database servers; and
removing the third database server from the plurality of database servers subject to scheduling.

20. The apparatus of claim 19, wherein the operations further include:
sorting database servers whose performance parameters do not exceed the predetermined threshold according to their respective workloads; and
selecting the third database server from the sorted database servers, wherein the third database server has a heaviest workload.

21. The apparatus of claim 13, wherein the operations further include:
determining a performance parameter associated with each database instance operating on each of the plurality of database servers subject to scheduling;
determining whether there exists a database instance whose performance parameter exceeds the predetermined threshold; and
when it is determined that there exists a database instance whose performance parameter exceeds the predetermined threshold, removing a corresponding database server hosting the database instance from the plurality of database servers subject to scheduling.

22. A non-transitory computer-readable medium storing instructions for performing database scheduling, wherein the instructions, when executed by a processor device, cause the processor device to perform operations including:
obtaining a performance parameter associated with each of a plurality of database servers that are subject to scheduling;
selecting, among the plurality of database servers subject to scheduling, a first database server, wherein the performance parameter associated with the first database server exceeds a predetermined threshold;
selecting a first database instance operating on the first database server; and
migrating the first database instance to a second database server that is capable of accepting the first database instance,
wherein the second database server is capable of accepting the first database instance when a combined performance parameter combining the performance parameter associated with the second database server and a performance parameter associated with the first database instance does not exceed the predetermined threshold.

23. The computer-readable medium of claim 22, wherein the operation of selecting the first database server includes:
sorting the plurality of database servers according to their respective workloads indicated by the corresponding performance parameters; and
selecting the first database server from the sorted plurality of database servers, wherein the first database server has a heaviest workload.

24. The computer-readable medium of claim 22, wherein the operation of selecting the first database instance includes:
determining whether the first database server includes a single database instance, when emigrating from the first database server, will reduce the performance parameter associated with the first database server to a level equal to or below the predetermined threshold.

25. The computer-readable medium of claim 24, wherein the operations further include:
when the single database instance exists, selecting the single database instance as the first database instance.

26. The computer-readable medium of claim 24, wherein the operations further include:
when the single database instance does not exist:
sorting database instances operating on the first database server according to their respective workloads; and
selecting the first database instance from the sorted database instances, wherein the first database instance has a heaviest workload.

27. The computer-readable medium of claim 22, wherein the operations further include:
sorting database servers whose performance parameters do not exceed the predetermined threshold according to their respective workloads; and
selecting the second database server from the sorted database servers, wherein the second database server has a heaviest workload.

28. The computer-readable medium of claim 22, wherein the operations further include:
selecting, among database servers whose performance parameters do not exceed the predetermined threshold, a third database server, on which one or more database instances operate;
for each of the one or more database instances, determining whether there exists a database server capable of accepting that database instance; and
when it is determined that for each of the one or more database instances, there exists a database server capable of accepting that database instance, migrating all database instances operating on the third database server into their respective accepting database servers; and
removing the third database server from the plurality of database servers subject to scheduling.

29. The computer-readable medium of claim 28, wherein the operations further include:
sorting database servers whose performance parameters do not exceed the predetermined threshold according to their respective workloads; and
selecting the third database server from the sorted database servers, wherein the third database server has a heaviest workload.

30. The computer-readable medium of claim 22, wherein the operations further include:
determining a performance parameter associated with each database instance operating on each of the plurality of database servers subject to scheduling;
determining whether there exists a database instance whose performance parameter exceeds the predetermined threshold; and
when it is determined that there exists a database instance whose performance parameter exceeds the predetermined threshold, removing a corresponding database server hosting the database instance from the plurality of database servers subject to scheduling.
